(19) United States
(12) Patent Application Publication
(10) Pub. No.: US 2005/0063319 A1
(43) Pub. Date: Mar. 24, 2005

(54) Channel assignment for scalable ad hoc network

(76) Inventors: Spyros Kyperountas, Coral Springs, FL (US); Vernon A. Allen, Fort Lauderdale, FL (US); Oleg Andric, West Palm Beach, FL (US)

Correspondence Address: MOTOROLA, INC., 1303 EAST ALGONQUIN ROAD, IL01/3RD, SCHAUMBURG, IL, 60196, US

(21) Appl. No.: 10/914,584

(22) Filed: Aug. 9, 2004

Related U.S. Application Data
(60) Provisional application No. 60/505,656, filed on Sep. 24, 2003.

(51) Int. Cl. H04J 3/22

(52) U.S. Cl. 370/254; 370/338

(57) ABSTRACT

To address the need for channel assignment in an ad-hoc network, a method and apparatus for channel assignment is provided herein. In particular, a communication system (100) utilizes a method for deterministic node (101-107) channel assignment that enables channel reuse and thus scalability of an ad-hoc network. The channel assignment is dependent upon a current level for the particular nodes, as well as the maximum available channels, the maximum allowable levels in the network, and the maximum number of children nodes that a parent can have.

### FIELD OF THE INVENTION

The present invention relates generally to ad-hoc networks and in particular, to a method and apparatus for channel assignment within such ad-hoc networks.

### BACKGROUND OF THE INVENTION

Interference often hinders performance of communication systems. One type of interference often encountered by a user within a communication system is interference generated by the transmissions of other users. This is typically caused by many users transmitting within the same frequency band, and is referred to as co-channel interference. In order to reduce co-channel interference many communication systems employ a frequency reuse pattern, where transmitters transmit on different frequencies. However, in a self-organizing network, the network does not know the geographical distribution of the transmitting nodes in advance. Notwithstanding this fact, the distribution frequently changes as the nodes move. Also, since the network is self-organizing, the logical links formed cannot be determined ahead of time. Thus, because co-channel interference hinders the performance of ad-hoc networks, and because there currently exists no method for adequately assigning channels within such ad-hoc networks, a need exists for a method and apparatus for channel assignment within an ad-hoc network that greatly reduces incidences of co-channel interference.

### BRIEF DESCRIPTION OF THE DRAWINGS

FIG. 1 is a block diagram of an ad-hoc network.

FIGS. 2-7 FIG. 2 illustrate channel assignment within a network having various values for Cₘ, Lₘ, inmod, and Sₘₐₓ,

FIG. 8 is a block diagram of a node within the communication system of FIG. 1.

FIG. 9 is a flow chart showing operation of the node of FIG. 8.

### DETAILED DESCRIPTION OF THE DRAWINGS

To address the need for channel assignment in an ad-hoc network, a method and apparatus for channel assignment is provided herein. In particular, a communication system utilizes a method for deterministic node channel assignment that enables channel reuse and thus scalability of an ad-hoc network. The channel assignment is dependent upon a current level for the particular nodes, as well as the maximum available channels, the maximum allowable levels in the network, and the maximum number of children nodes that a parent can have.

The present invention encompasses a method for channel assignment within an ad-hoc network. The method comprises the steps of determining a number of hops to a root node (Li), determining a channel (S_{Li,}) based on the number of hops to the root node, and transmitting data utilizing the channel.

The present invention additionally encompasses an apparatus comprising a microprocessor determining a number of hops to a root node (Li) and a channel (S_{Li,}) based on the number of hops to the root node, and RF circuitry transmitting data utilizing the channel.

Turning now to the drawings, wherein like numerals designate like components, FIG. 1 is a block diagram of ad-hoc network 100. As is evident, ad-hoc network 100 comprises a plurality of network nodes 101-107 in communication with each other. Ad-hoc network 100 preferably utilizes a neuRFon™ system protocol as described in U.S. patent application Ser. No. 09/803259. As one of ordinary skill in the art will recognize, within the neuRFon™ system protocol single node 104 serves as a root node, other nodes 103, 105 (referred to as “children nodes”) form a direct link to root node 104, up to a maximum number (Cₘ) of children nodes. In a similar manner, each child node 101-103 and 105-107 can have, up to Cₘ child nodes themselves. Thus, in FIG. 1, where Cₘ=2, root node 104 has two child nodes 103 and 105. In a similar manner, child nodes 103 and 105 each have two child nodes in direct communication with them. Particularly, child node 103 has nodes 101 and 102 in direct communication with it, while child node 105 has nodes 106 and 107 in direct communication with it.

Each node 101-107 within communication system 100 is assigned a value (level) that indicates how many hops in communication the node is from root node 104. For example, root node 104 is at level 0, while nodes 103 and 105 are at level 1, being 1 “hop” from root node 104. In a similar manner, nodes 101, 102, 106, and 107 are at level 2 in that they are two hops from root node 104. Thus, if Cₘ is the maximum number of children a node can have, then for a given level (Lᵢ) there exists (Cₘ)^{L}ᵢ nodes that can exist at level Lᵢ. Additionally, nodes at a particular level are assigned a node number (j), that indicates, for example, an order in which the nodes joined the particular level. Thus, with reference to FIG. 1, node 101 has Lᵢ=2, j=1, since it is the first node at level 2, node 102 has Lᵢ=2, j=2 since it is the second node at level 2, . . . , etc.

As described above, co-channel interference often hinders performance of communication systems. Thus, it is important for all nodes 101-107 within communication system 100 to be assigned channels of communication that reduce co-channel interference. In order to address this issue, communication system 100 utilizes a method for deterministic node channel assignment that enables channel reuse and thus scalability of an ad-hoc network. The channel assignment is dependent upon a current level for the particular nodes. In particular, the channel assignment (S_{Li,j}) of each node is based on the following algorithm:
S_{Li,j}=mod(mod(j,inmod)+inmod*(Lₘ−Lᵢ),Sₘₐₓ), j=1→Cₘ^{L}^{ᵢ}, Lᵢ=0→Lₘ, (1)
where:
SLij is the channel assignment for node j in level Lᵢ;
Sₘₐₓ is the maximum available channels;
Lₘ is the maximum allowable levels in the network;
Cₘ is maximum number of children nodes that a parent can have; and
inmod is a number that defines the channel spread among neighboring nodes.

It should be noted that the determination of inmod is crucial to the optimum channel assignment in the network and depends on the designed Cₘ of the network. It is desirable to have inmod as large as possible without having any node operate such that its parent and any of its children share the same channel. Table 1 gives the values for inrmod for various Cₘ, Sₘₐₓ=16, and 8 bit address assignment.

TABLE 1
Maximum inmod values.

| Cₘₐₓ | Maximum inmod |
|---|---|
| 2 | 5 |
| 3 | 5 |
| 4 | 5 |
| 5 | 5 |
| 6 | 7 |
| 7 | 7 |

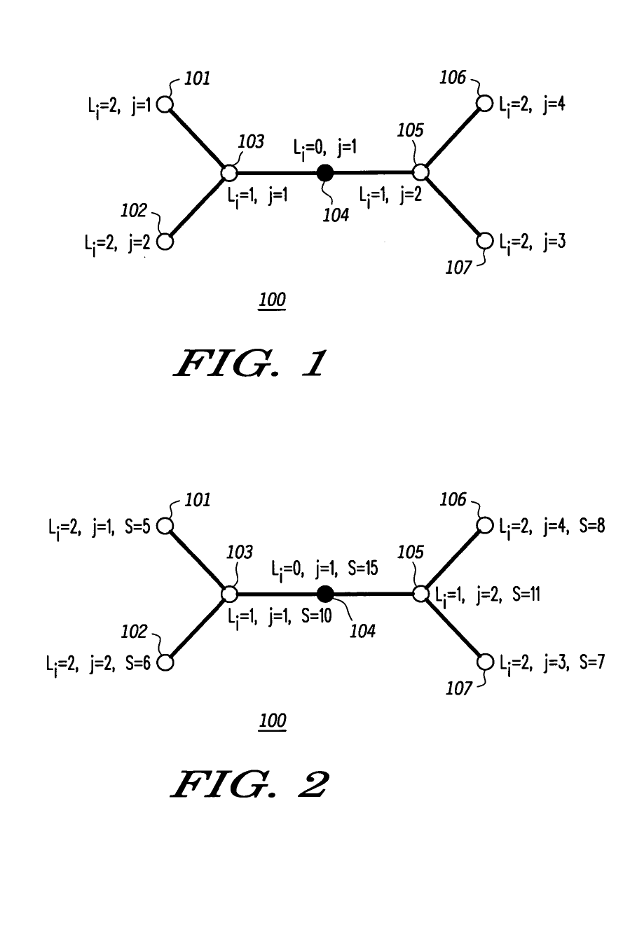

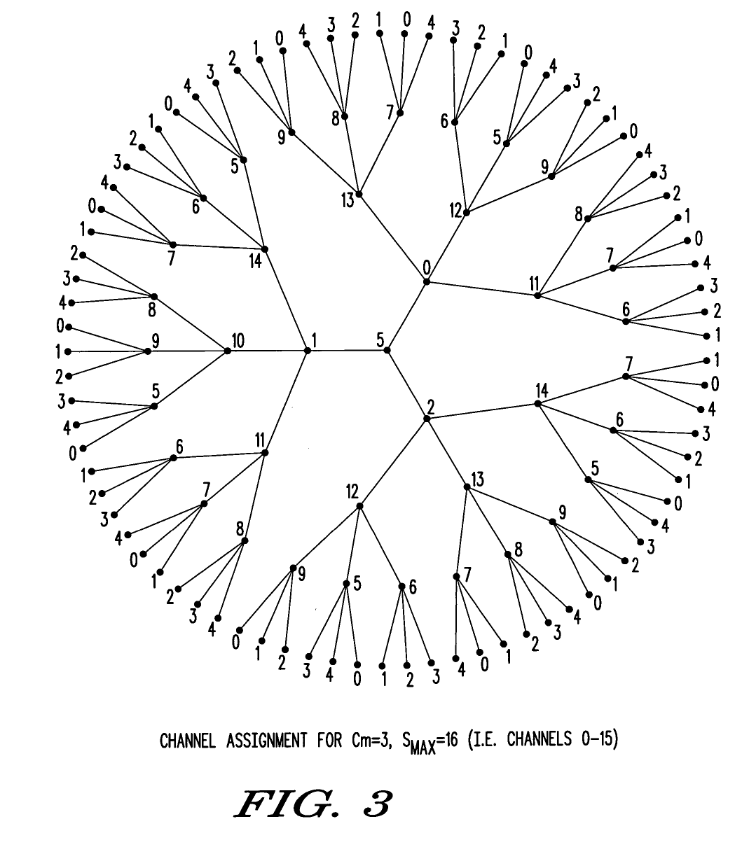

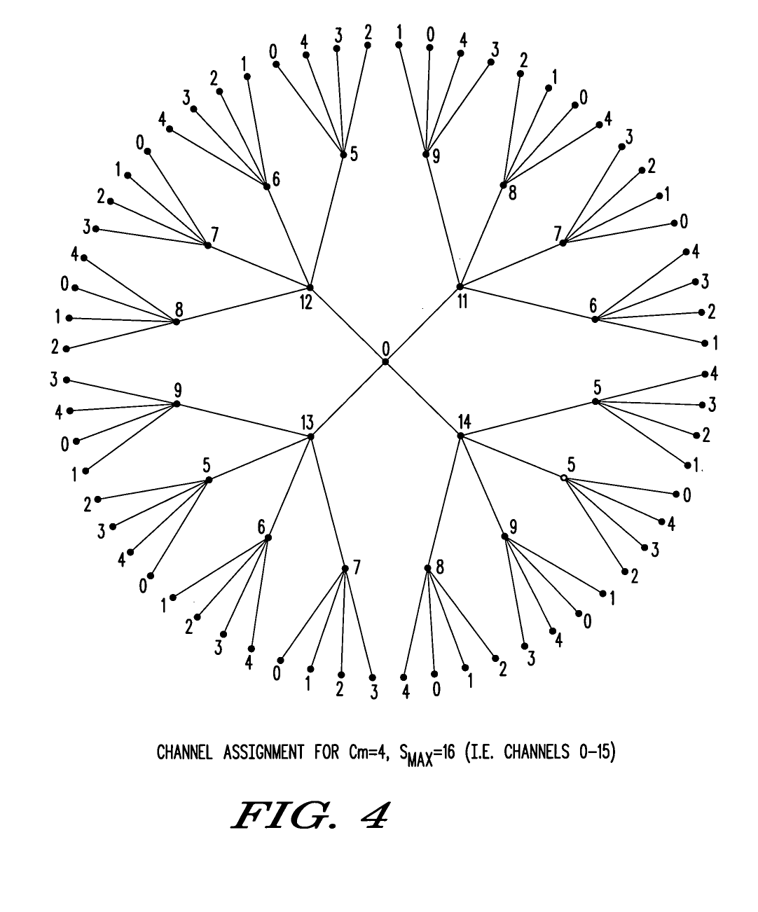

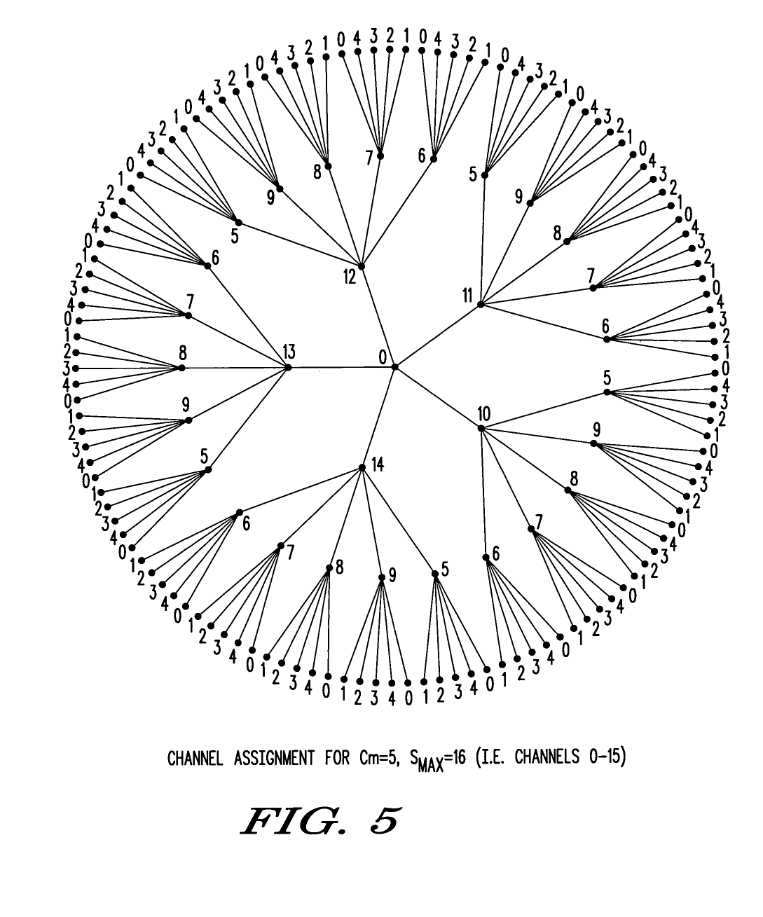

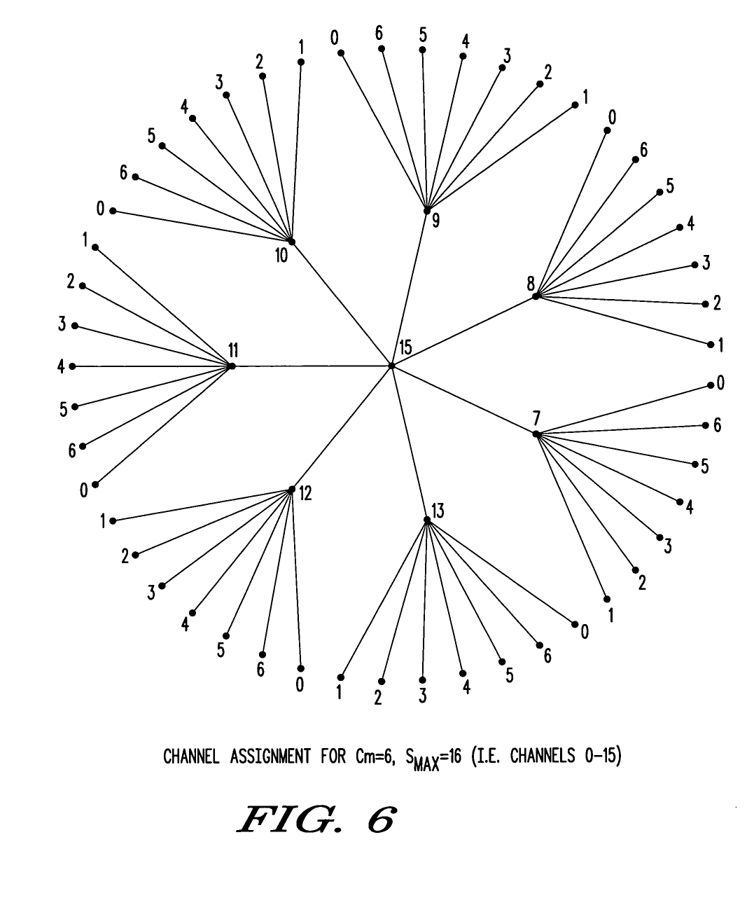

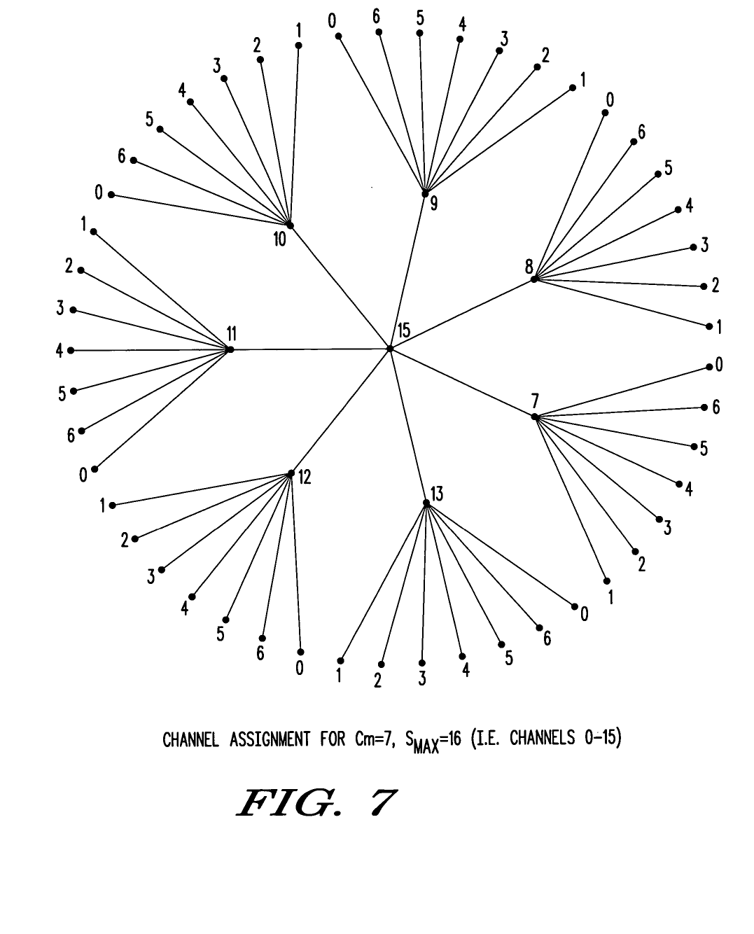

To better illustrate the above-described channel assignment, FIG. 2 shows a network with Cₘ=2, Lₘ=7, inmod=5, and Sₘₐₓ=16 (i.e. channels 0-15). As is evident, utilization of the above channel-assignment scheme results in channel 5 being assigned for node 101, while S=6, 10, 15, 11, 8, and 7 for nodes 102-107, respectively. The above-described channel assignment can also be extended to situations where Cₘ>2. This is illustrated in FIGS. 3-7, where the number next to each node refers to the particular channel being utilized by that node.

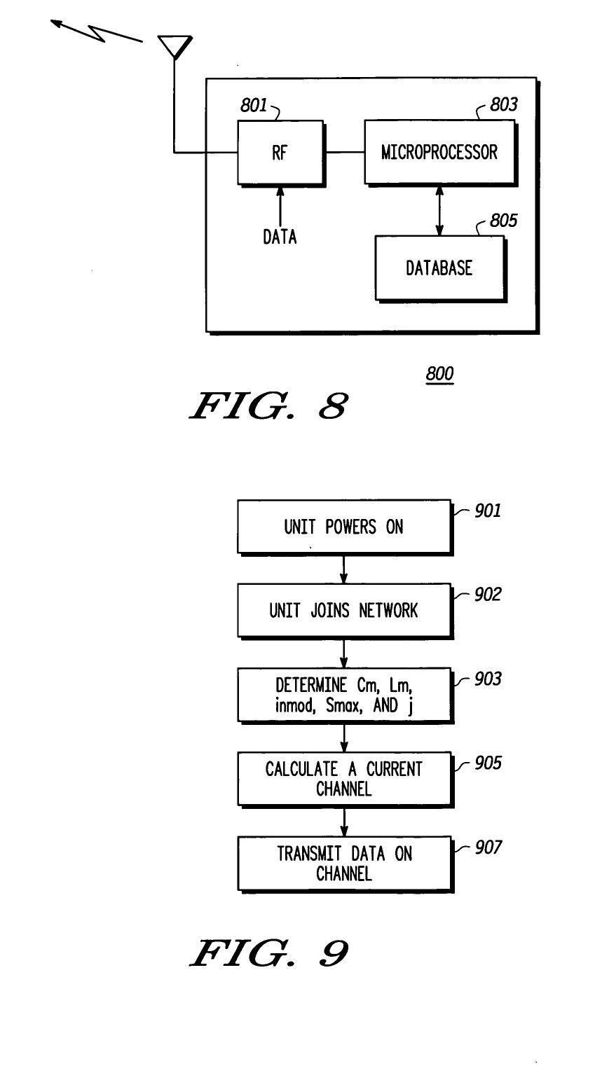

FIG. 8 is a block diagram of node 800 that utilizes the above-described channel assignment scheme. As illustrated node 800 comprises RF circuitry 801 and microprocessor 803. After a node turns on, RF circuitry 801 listens and searches for a HELLO message from other nodes. (A HELLO message is a simple broadcast message identifying the transmitting node). If a HELLO message is heard from other nodes, node 800 determines (via information transmitted in the HELLO messages or via exchanging an additional message(s) with the nodes or by using some other criteria) which node to join as a child. Then the node 800 joins the network (by transmitting the association request to and receiving an association response from the parent node). After joining the network the node 800 makes the appropriate channel selection. This could be done in several ways. One way is for the node 800 to receive Cₘ, Lₘ, inmod, and Sₘₐₓ, as well as parent's Lᵢ₋₁, and j (which child—i.e. first, second, and so on the node 800 is in its layer Lᵢ) and then to calculate its own appropriate channel. Alternatively, inmod and Sₘₐₓ could be preloaded into the node 800.

The parent node may calculate the appropriate channel for its child (e.g., node 800), and to transmit that information to the node 800 which from then on uses that channel for its HELLO messages. Also note that in this case the parent would additionally transmit Cₘ and Lₘ to the node 800 so that it can use that information to calculate channel assignment for its own children (which might join in future). In the situation where node 800 acts as a root node of the network, it will not receive Cₘ, Lₘ, inmod, and Sₘₐₓ over the air. In this case the root node must have these values preloaded and makes the appropriate channel selection.

FIG. 9 is a flow chart showing operation of node 800. The logic flow begins at step 901 where node 800 powers on. At step 903 microprocessor 803 determines Cₘ, Lₘ, inmod, Sₘₐₓ, Lᵢ and j. As discussed above, how microprocessor 803 determines these values may vary in various embodiments of the present invention. For example, if node 800 is acting as a root node, the values of Cₘ, Lₘ, inmod, Sₘₐₓ, Lᵢ and j are preferably preprogrammed in node 800, existing in database 805. Alternatively, if node 800 is acting as a child node, the values of Cₘ, Lₘ, inmod, Sₘₐₓ, Lᵢ and j may be obtained through its parent. Regardless of how these values are obtained, microprocessor 803 calculates a current channel (S_{Li,j}) based on Cₘ, Lₘ, inmod, Sₘₐₓ, Lᵢ and j (step 905). As is evident, S_{Li,j} is a scalar value between 0 and Sₘₐₓ. One of ordinary skill in the art will recognize that an association must be made between S_{Li,j} and an actual channel (e.g., frequency, time slot, spreading code, . . . , etc.). This can easily be made by accessing information stored in database 805. More particularly, database 805 preferably contains an association, in table form, between each value of S_{Li,j} and a corresponding frequency, time slot, spreading code, . . . etc. By accessing database 805 with the value of S_{Li,j}, an appropriate transmission channel is obtained.

Continuing, at step 907 data is transmitted by node 800 utilizing RF circuitry 801 transmitting on the particular channel. More particularly, microprocessor 803 instructs RF circuitry 801 of the particular channel to utilize. RF circuitry 801 is well known circuitry designed to transmit utilizing the particular transmission protocol being utilized by communication system 100. Data enters RF transmitter and is appropriately error controlled, encoded, modulated, and transmitted on the particular channel.

While the invention has been particularly shown and described with reference to a particular embodiment, it will be understood by those skilled in the art that various changes in form and details may be made therein without departing from the spirit and scope of the invention. For example, although the variable “j” was described above as a number indicating an order in which a node joined a particular level, in alternate embodiments, the variable j could be chosen by a node based on any available channel, as long as the variable is unique to each node within a particular level. More particularly, when a node decides the channel it will be using, in reality it has many options based on this algorithm (i.e. it can be any j (and thus any channel associated with that j) that belongs to the parent it joined). The choice of the proper j (or channel) that the node will chose, could come after the node knows its channel available to choose (this info could come from the parent), and monitors the channels and chooses a channel that it is not in use. This simply gives the node the flexibility to avoid even further using a channel that a neighboring node from a neighboring tree branch uses. It is intended that such changes come within the scope of the following claims.

1. A method for channel assignment within an ad-hoc network, the method comprising the steps of:
determining a number of hops to a root node (Li);
determining a channel (S_{Li}) based on the number of hops to the root node; and
transmitting data utilizing the channel.

2. The method of claim 1 further comprising the step of:
determining a maximum number of available channels (Sₘₐₓ); and
wherein the step of determining the channel is additionally based on Sₘₐₓ.

3. The method of claim 1 further comprising the step of:
determining a maximum allowable levels in the network (Lₘ); and
wherein the step of determining the channel is additionally based on Lₘ.

4. The method of claim 1 further comprising the step of:
determining a maximum number of children nodes (Cₘ) that a parent can have; and
wherein the step of determining the channel is additionally based on Cₘ.

5. The method of claim I further comprising the step of:
determining a channel spread among neighboring nodes (inmod); and
wherein the step of determining the channel is additionally based on inmod

6. The method of claim 1 further comprising the step of:
determining a node number (j), that indicates a unique number assigned to each nodel; and
wherein the step of determining the channel is additionally based on j.

7. The method of claim 1 further comprising the steps of:
determining a maximum number of available channels (Sₘₐₓ);
determining a maximum allowable levels in the network (Lₘ);
determining a maximum number of children nodes (Cₘ) that a parent can have;
determining a node number (j), that indicates an order in which a node joined a particular level
determining a the channel spread among neighboring nodes (inmod); and
wherein the step of determining the channel comprises the step of determining
S_{Li,j}=mod(mod(j,inmod)+inmod*(Lₘ−Lᵢ),Sₘₐₓ), j=1→Cₘ^{L}^{ᵢ}, Lᵢ=0→Lₘ

8. An apparatus comprising:
a microprocessor determining a number of hops to a root node (Li) and a channel (S_{Li}) based on the number of hops to the root node; and
RF circuitry transmitting data utilizing the channel.

9. The apparatus of claim 8 wherein the microprocessor additionally determines a maximum number of available channels (Sₘₐₓ), and the channel is additionally based on Sₘₐₓ.

10. The apparatus of claim 8 wherein the microprocessor additionally determines a maximum allowable levels in the network (Lₘ), and the channel is additionally based on Lₘ.

11. The apparatus of claim 8 wherein the microprocessor additionally determines a maximum number of children nodes (Cₘ) that a parent can have, and the channel is additionally based on Cₘ.

12. The apparatus of claim 8 wherein the microprocessor additionally determines a channel spread among neighboring nodes (inmod), and the channel is additionally based on inmod.

13. The apparatus of claim 8 wherein the microprocessor additionally determines a node number (j) that indicates an order in which a node joined a particular level, and the channel is additionally based on j.

14. The apparatus of claim 8 wherein the microprocessor additionally determines a maximum number of available channels (Sₘₐₓ), a maximum allowable levels in the network (Lₘ), a maximum number of children nodes (Cₘ) that a parent can have, a the channel spread among neighboring nodes (inmod), a node number (j), that indicates an order in which a node joined a particular level, and wherein the step of determining the channel comprises the step of determining
S_{Li,j}=mod(mod(j,inmod)+inmod*(Lₘ−Lᵢ),Sₘₐₓ), j=1→Cₘ^{L}^{ᵢ}, Lᵢ=0→Lₘ
